(19) United States
(12) Patent Application Publication
(10) Pub. No.: US 2006/0175136 A1
(43) Pub. Date: Aug. 10, 2006

(54) Rooftop control unit for an elevator system having a removable cover

(75) Inventors: Leandre Adifon, Farmington, CT (US); Bruce P Swaybill, Farmington, CT (US); Bruce St Pierre, Bristol, CT (US)

Correspondence Address: OTIS ELEVATOR COMPANY;INTELLECTUAL PROPERTY DEPARTMENT, 10 FARM SPRINGS, FARMINGTON, CT, 06032, US

(73) Assignee: Otis Elevator Company, Farmington, CT (US)

(21) Appl. No.: 10/520,756

(22) PCT Filed: Jul. 18, 2002
(86) PCT No.: PCT/US02/23248

§ 371 Date: Jul. 13, 2005

(51) Int. Cl. B66B 9/02

(52) U.S. Cl. 187/250

(57) ABSTRACT

A rooftop unit for a machine-roomless elevator (28) includes a selectively removable cover (38) that covers the machine components (46). In one example, the removable cover is movable relative to the rooftop without requiring removal of the entire cover.

### BACKGROUND OF THE INVENTION

This invention generally relates to machine-roomless elevator systems. More particularly, this invention relates to a rooftop mounted unit that houses the components used to operate the elevator system as desired.

Elevator systems typically include a cab that moves within a hoistway. Most systems include a counterweight that is associated with the cab. Roping typically couples the cab to the counterweight. A drive motor rotates a drive sheave to move the roping to cause the desired movement of the elevator cab within the hoistway.

Traditionally, elevator systems have required a machine room for housing the drive motor, the drive sheave and other operation control components. Such components typically are referred to collectively as the “machine,” which is the basis for the “machine room” designation. Machine rooms often were located on top of buildings. The use of machine rooms, while effective, is not without drawbacks. A building construction must be specifically arranged to fit or support the machine room and the components within it. In some instances, special architectural considerations are needed to adequately support the machine room at the rooftop level.

Machine rooms introduce additional material cost and other construction issues for designers and during building construction.

More recently, it has been proposed to eliminate machine rooms and to otherwise house the drive and control components of an elevator system. A variety of approaches in this regard have been proposed. This invention provides a unique, compact and cost effective solution where it is desirable to eliminate an elevator system machine room.

### SUMMARY OF THE INVENTION

In general terms, this invention is a rooftop unit that houses the machine components of an elevator system under a removable cover that can be opened or removed for maintenance or component replacement as needed. The rooftop unit sits atop a roof surface of a building without requiring special construction to accommodate the rooftop unit.

One example assembly designed according to this invention includes a support base that is adapted to be secured to the roof surface. The support base supports at least some of the elevator system machine components. The support base has an opening through which selected portions of the elevator system extend, such as the roping, to achieve desired elevator system operation. A cover is removably secured to the support base to cover the machine components supported on the base.

One example cover designed according to this invention includes at least one access panel extending through the cover. A portion of the cover is selectively moveable relative to a remainder of the cover to open or close the access opening. In one example, up to one-half of the cover can be manually moved to provide access to the machine components.

The cover and support base preferably provide a watertight seal that prevents natural elements from entering the space beneath the cover for protecting the machine components and preventing the natural elements from entering the hoistway through the opening in the support base.

In one example, the cover is completely removable. The cover preferably is infrequently completely removed but that option is available with this invention.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates an elevator system of an example embodiment designed according to this invention.

FIG. 2 is a partial exploded schematic illustration of an example assembly designed according to an embodiment of this invention.

FIG. 3 schematically shows another example cover.

### DETAILED DESCRIPTION OF THE PREFERRED EMBODIMENTS

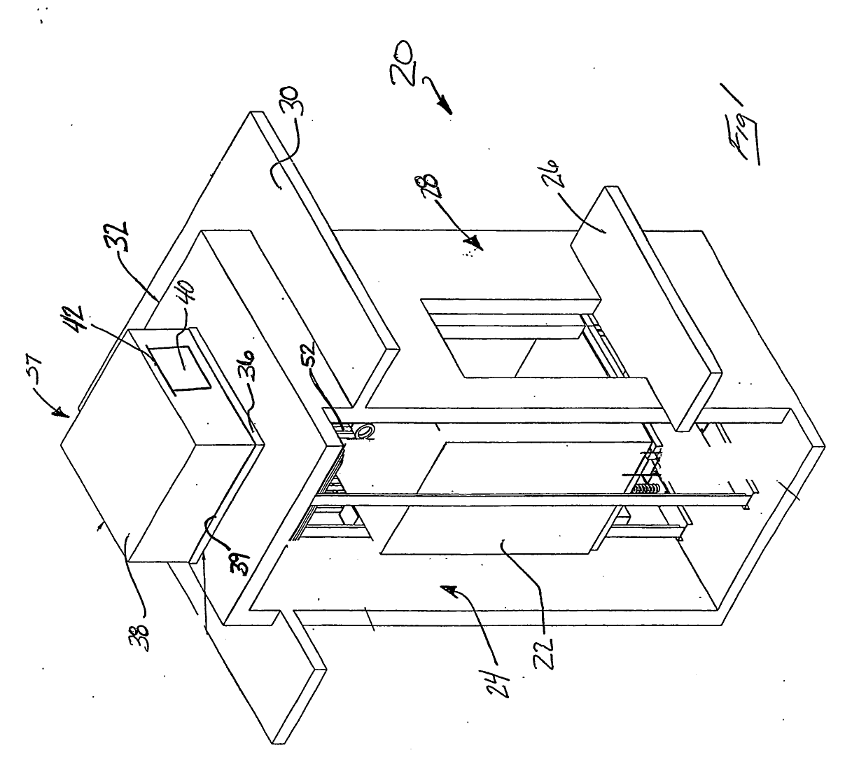

An elevator system 20 is schematically illustrated in FIG. 1. The system 20 includes an elevator cab 22 that is selectively moveable within a hoistway 24 to carry loads between different levels or landings 26 of a building 28. Only selected portions of the cab supporting structure within the hoistway 24 are schematically illustrated and although only one landing 26 is shown, those skilled in the art appreciate that an elevator system typically provides access to multiple levels or landings within a building.

The building 28 includes a roof surface 30. The illustrated example includes a hoistway top portion 32 that extends slightly above the majority of the roof surface. There may be situations where this invention is applicable that the hoistway top portion 32 is no higher than the roof surface 30.

A rooftop unit 34 is secured to the hoistway top portion 32. The illustrated example rooftop unit 34 includes a support base 36 and a cover 38. The support base 36 preferably is permanent secured to the rooftop 30 or the hoistway top portion 32. In one example, the base 36 comprises a set of at least two horizontally positioned beams above the hoistway. The rooftop 30 and the hoistway top portion 32 are generically referred to in this document as a “roof surface.”

The cover 38 preferably is not permanently secured to the rooftop or the support base 36. Instead, the cover 38 preferably is removable from the support base to provide access to components supported by the support base 36. In one example, a crane or other similar machine is required to remove the entire cover 38. In another example, only a portion of the cover is removable.

The cover 38 preferably is received to establish a closed interface 39 between the cover and the support base 36. An example securing arrangement includes fasteners such as bolts securing the cover to the base. In one example, no separate sealing elements or materials are required at the interface 39.

In another example, the roof surface includes a curb portion formed as part of the roof surface. The curb portion operates as the edges of the support base 36 for receiving the cover 38 in a manner that protects the machine components from the natural elements.

The illustrated example of FIG. 1 includes an access opening 40 through one side of the cover 38. The illustrated example includes a hinged support 42 that allows a portion of the cover 38 to be selectively moved to provide access to the interior of the unit 34 through the access opening 40. Although one access opening is shown in FIG. 1, a plurality of such openings and a variety of items for selectively covering such openings are within the scope of this invention.

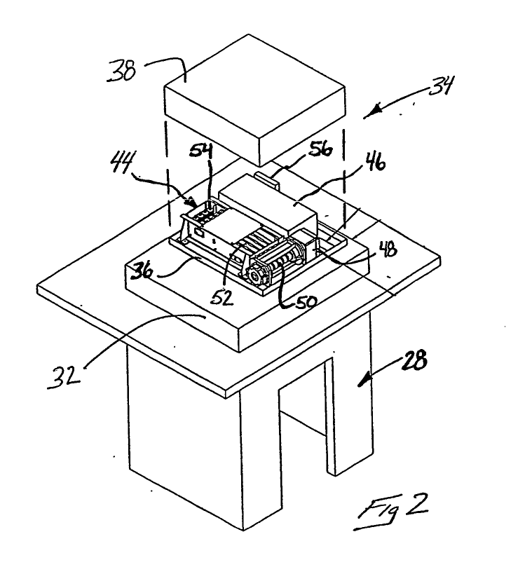

As best appreciated from FIG. 2, the support base 36 preferably supports a machine assembly 44 that provides the motive force for moving the elevator cab 22 as desired within the hoistway 24. The machine assembly 44 preferably is very compact compared to traditional machine assemblies that required an entire machine room to house the motor and other components. The illustrated example includes a motor controller 46 that controls operation of a motor 48, which preferably is an electric motor. A drive sheave 50 rotates responsive to movement of the motor 48 to cause movement of a plurality of belts (i.e., roping) 52 over the drive sheave 50 so that the cab 22 moves as desired. A plurality of belt terminations 54 preferably are supported within the rooftop unit 34.

Additionally, a temperature control device 56, such as a fan or a heater, may advantageously be supported in the rooftop unit 34.

The support base 36 and cover 38 together form a housing for completely housing the machine assembly 44 components that are supported above the roof surface of the building. An opening (not visible in the illustrations) through the support base 36 allows the roping 52 to extend down into the hoistway so that appropriate elevator system operation occurs.

In one example, the total height of the rooftop unit 34 above the roof surface of the hoistway top 32 is less than one meter. In one example, the top of the cover 38 is only approximately 77 cm (2 feet 7 inches) above the top surface of the hoistway top 32. The overall dimensions of the assembly 34 are significantly reduced compared to machine rooms that were traditionally supported above roof surfaces.

A variety of materials may be used to make the cover, support base or both. Examples include stainless steel, aluminum, fiberglass, and plastic. The chosen material must withstand the anticipated environmental conditions of that building location. Those who have the benefit of this description will realize what materials will meet the particular needs of a specific situation and will be able to select the material best suited for their situation.

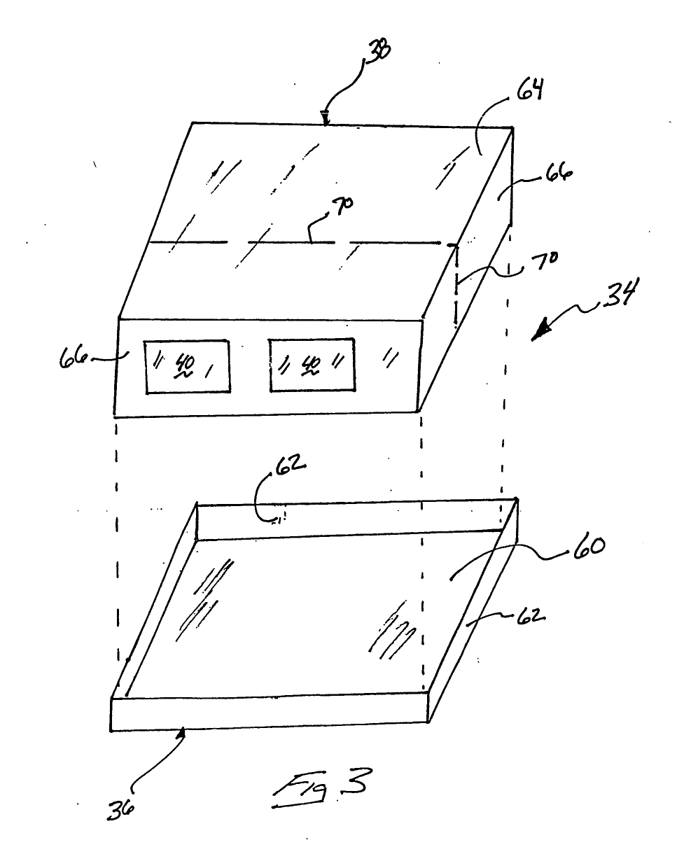

As best seen in FIG. 3, the support base 36 in the illustrated examples includes a generally planar base surface 60. A plurality of side portions 62 extend upward (relative to the rooftop) away from the planar surface 60. The height of the side portion 62 preferably is chosen based upon the typical rainfall in the region where the building is located. Snowfall, when expected, also must be accommodated to ensure adequate machine component protection. Local building codes may dictate requirements for the side portion 62 height. In one example, the height is 200 mm.

The cover 38 includes a top portion 64 and a plurality of sidewalls 66 extending away from the top portion. In the illustrated example, the sidewalls 66 of the cover 38 are received within the space defined by the side portion 62 of the support base 36. An appropriate fit at the interface between the sidewalls 66 and the side portions 62 ensures that natural elements (i.e., rain or snow) do not enter the space protected by the cover 38 so that the machine components supported by the support base 36 remain isolated from the environment as desired.

The example of FIG. 3 includes a hinged connection 70 between portions of the cover 38. In this example, the forward side (according to the drawing) can be manually lifted about the hinged connection to provide access beyond that available through the openings 40.

A significant advantage of this invention is the space savings provided by the unique and compact arrangement of components. Another significant advantage is having a selectively removable cover 38 that allows for an individual to readily access the components within the rooftop unit 34 for installation, maintenance or replacement as may be needed.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-18. (canceled)

19. An elevator system, comprising:
a cab adapted to carry a load between different levels of a building;
a machine assembly secured to a roof surface on the building and having a drive sheave that causes movement of at least one elongated tension member such that the cab moves as desired and a motor that moves the drive sheave; and
a cover removably secured over the machine assembly to cover over the machine assembly.

20. The system of claim 19, including a support base secured to the roof surface that supports the machine assembly, the cover being selectively removable from the support base.

21. The system of claim 20, wherein the support base includes a first generally planar surface with a plurality of side portions extending away from the surface and wherein the cover includes a corresponding plurality of side walls that are received against the side portions when the cover is secured to the support base.

22. The system of claim 21, wherein the side portions are exterior to the side walls when the cover is secured to the support base.

23. The system of claim 19, including an electronic controller that controls the motor supported beneath the cover.

24. The system of claim 19, wherein the cover includes an access opening through the cover and a cover portion that selectively closes off the access opening.

25. The system of claim 19, wherein the cover includes a portion that is moveable relative to another portion of the cover to provide access to at least some of the machine assembly.

26. The system of claim 19, wherein the cover has a top surface and a plurality of side walls extending away from edges of the top surface less than one meter such that the height of the cover from the roof surface is less than one meter when the cover is secured in place.

27. The system of claim 19, including a temperature control device associated with the machine assembly for controlling the temperature within the space covered by the cover.

28. The system of claim 19, wherein the tension member comprises a flat belt.

29. The system of claim 28, including a plurality of flat belts and a plurality of terminations supporting at least one end of the belts, the terminations being covered over by the cover.

30. The system of claim 19, including a termination supporting at least one end of the tension member and wherein the cover covers the termination.

31. The system of claim 30, wherein there are a plurality of tension members and a plurality of terminations with each termination being covered by the cover.

32. The system of claim 31, wherein the cover has a height of less than one meter.

33. An assembly for housing elevator system machine components on top of a roof surface of a building without requiring a machine room, comprising:
a support base adapted to be secured to the roof surface, the support base supporting at least some of the machine components; and
a cover that is selectively secured to the support base to cover the machine components supported on the base.

34. The system of claim 33, wherein the cover includes an access opening through the cover and a cover portion that selectively closes off the access opening.

35. The system of claim 33, wherein the cover has a top surface and a plurality of side walls extending away from edges of the top surface less than one meter such that the height of the cover from the roof surface is less than one meter when the cover is secured to the support base.

36. The system of claim 33, including a temperature control device associated with the support base for controlling the temperature within the space covered by the cover.

37. The system of claim 33, wherein the support base includes a first generally planar surface with a plurality of side portions extending away from the surface and wherein the cover includes a corresponding plurality of side walls that are received against the side portions when the cover is secured to the support base.

38. The system of claim 37, wherein the side portions are exterior to the side walls when the cover is secured to the support base.

39. The assembly of claim 33, wherein the entire cover is removable.

40. The assembly of claim 33, wherein the machine comprises a motor and a drive sheave that rotates responsive to the motor to move at least one tension member in a manner that causes a desired elevator cab movement.

41. The assembly of claim 40, including at least one termination that supports at least one end of the tension member and wherein the termination is at least partially contained between the support base and the cover.

42. The assembly of claim 40, wherein the tension member comprises at least one flat belt.

43. The assembly of claim 33, wherein the cover has a height that is less than one meter.
